(19) United States
(12) Patent Application Publication
(10) Pub. No.: US 2020/0391659 A1
(43) Pub. Date: Dec. 17, 2020

(54) Occupancy Alerting Device

(71) Applicant: James Wiley, Fort Mill, SC (US)

(72) Inventor: James Wiley, Fort Mill, SC (US)

(21) Appl. No.: 16/441,198

(22) Filed: Jun. 14, 2019

(51) Int. Cl. B60Q 9/00; G08B 21/02; G08B 3/10

(52) U.S. Cl. CPC B60Q 9/00; G08B 3/10; G08B 21/02

(57) ABSTRACT

An occupancy alerting device for warning a driver of a child occupant in a vehicle includes a housing that is configured to be positioned in a passenger compartment of a vehicle by a driver who is transporting a child. A power module, a microprocessor, and a detector are coupled to the housing and are positioned in an interior space defined by the housing. A speaker is coupled to the housing. The microprocessor is operationally coupled to the power module, the detector, and the speaker. The detector is motion type and thus is configured to detect motion of the vehicle. The microprocessor is positioned to selectively actuate the speaker, based on a motion status of the vehicle, to broadcast an occupancy alert to an area proximate to the housing to alert the driver to the child in the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed under 37 CFR 1.97 and 1.98

The disclosure and prior art relate to alerting devices and more particularly pertain to a new alerting device for warning a driver of a child occupant in a vehicle.

### BRIEF SUMMARY OF THE INVENTION

An embodiment of the disclosure meets the needs presented above by generally comprising a housing that is configured to be positioned in a passenger compartment of a vehicle by a driver who is transporting a child. A power module, a microprocessor, and a detector are coupled to the housing and are positioned in an interior space defined by the housing. A speaker is coupled to the housing. The microprocessor is operationally coupled to the power module, the detector, and the speaker. The detector is motion type and thus is configured to detect motion of the vehicle. The microprocessor is positioned to selectively actuate the speaker, based on a motion status of the vehicle, to broadcast an occupancy alert to an area proximate to the housing to alert the driver to the child in the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an occupancy alerting device according to an embodiment of the disclosure.

FIG. 2 is an in-use view of an embodiment of the disclosure.

FIG. 3 is a flow diagram view of an embodiment of the disclosure.

FIG. 4 is a block diagram of an embodiment of the disclosure.

### DETAILED DESCRIPTION OF THE INVENTION

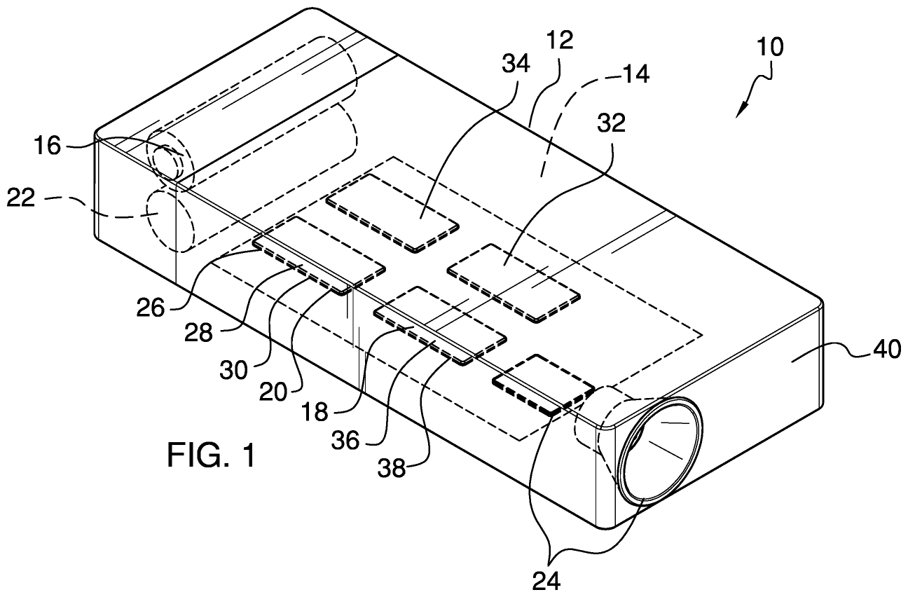

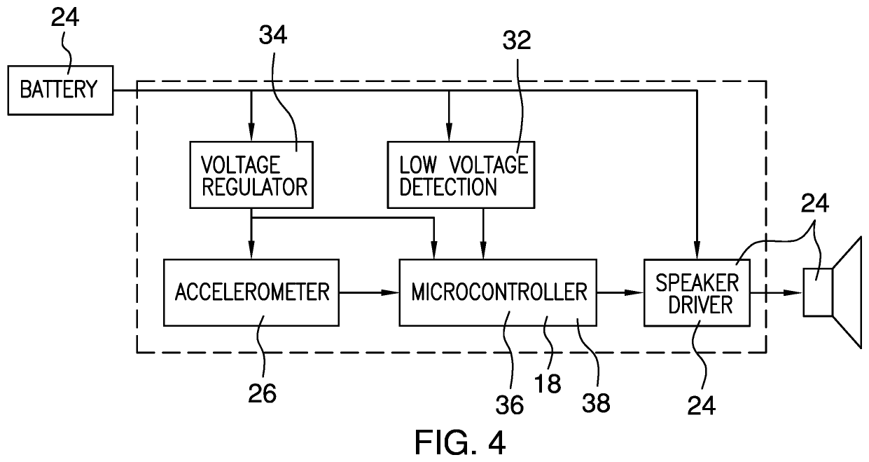

With reference now to the drawings, and in particular to FIGS. 1 through 4 thereof, a new alerting device embodying the principles and concepts of an embodiment of the disclosure and generally designated by the reference numeral 10 will be described.

As best illustrated in FIGS. 1 through 4, the occupancy alerting device 10 generally comprises a housing 12 that is configured to be positioned in a passenger compartment of a vehicle by a driver who is transporting a child. The housing 12 defines an interior space 14 and is substantially rectangularly box shaped. A power module 16, a microprocessor 18, and a detector 20 are coupled to the housing 12 and are positioned in an interior space 14 defined by the housing 12, as shown in FIG. 1. The power module 16 comprises a battery 22. A speaker 24 that is coupled to the housing 12 is positioned on a respective opposing end 40 of the housing 12.

The microprocessor 18 is operationally coupled to the power module 16, the detector 20, and the speaker 24. The detector 20 is motion type and thus is configured to detect motion of the vehicle. The microprocessor 18 is positioned to selectively actuate the speaker 24, based on a motion status of the vehicle, to broadcast an occupancy alert to an area proximate to the housing 12 to alert the driver to the child in the vehicle. The detector 20 comprises at least one of an accelerometer 26, a gyroscope 28, and a compass 30. The detector 20 comprises an accelerometer 26, which is multi-axis type.

A voltmeter 32 is coupled to the housing 12 and is positioned in the interior space 14. The voltmeter 32 is operationally coupled to the microprocessor 18 and the battery 22 so that the voltmeter 32 is positioned to relay a voltage reading of the battery 22 to the microprocessor 18, positioning the microprocessor 18 to selectively actuate the speaker 24 to broadcast a low voltage alert to the area proximate to the housing 12 to alert the driver to change the battery 22.

A voltage regulator 34 is coupled to the housing 12 and is positioned in the interior space 14. The voltage regulator 34 is operationally coupled to the microprocessor 18, the detector 20, and the battery 22 so that the voltage regulator 34 is positioned to provide a constant voltage from the battery 22 to the microprocessor 18 and the detector 20.

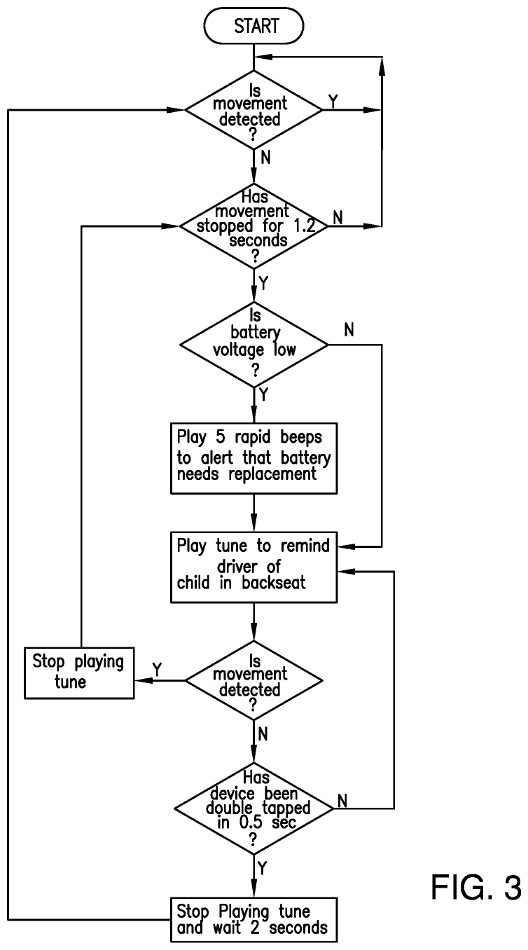

Occupancy alert programming code 36 that is positioned on the microprocessor 18 enables the microprocessor 18 to selectively actuate the speaker 24, based on the motion status of the vehicle, to broadcast the occupancy alert to the area proximate to the housing 12 to alert the driver to the child in the vehicle. For example, as shown in FIG. 3, the occupancy alert programming code 36 may enable the microprocessor 18 to actuate the speaker 24 to broadcast the occupancy alert after a first set time, perhaps 1.2 seconds, from a time when the detector 20 fails to detect motion of the vehicle. The occupancy alert, such as a tune, would be broadcast until the detector 20 detects movement of the vehicle or until the driver “taps” the housing 12 a set number of times, perhaps twice within 0.5 seconds, which would be detected by the detector 20. The occupancy alert programming code 36 then may enable the microprocessor 18 to actuate the speaker 24 to broadcast the occupancy alert after a second set time, perhaps two seconds, from a time when the detector 20 fails to detect motion of the vehicle.

Low voltage alert programming code 38 that is positioned on the microprocessor 18 enables the microprocessor 18 to selectively actuate the speaker 24, based on the voltage reading of the battery 22, to broadcast the low voltage alert to the area proximate to the housing 12 to alert the driver to change the battery 22. For example, the low voltage alert programming code 38 may enable the microprocessor 18 to actuate the voltmeter 32 obtain a voltage reading of the battery 22 each time the detector fails to detect motion of the vehicle, as shown in FIG. 3. Should the voltage of the battery fall below a preset value, the low voltage alert programming code 38 would enable the microprocessor 18 actuate the speaker 24 to broadcast the low voltage alert to the area proximate to the housing 12 to alert the driver to change the battery 22.

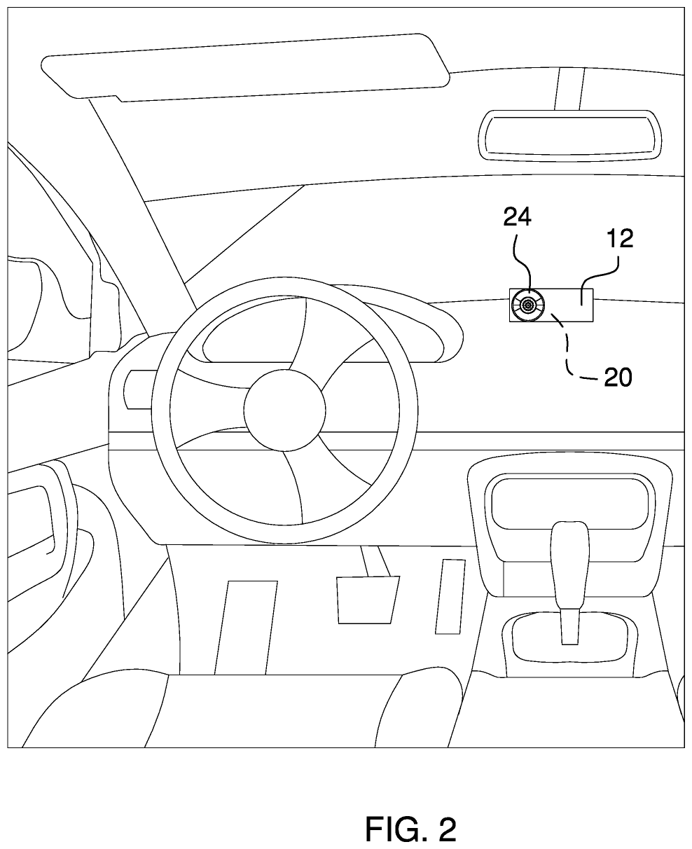

In use, the driver who will be transporting the child positions the housing 12 in the passenger compartment of a vehicle, perhaps on the dash as shown in FIG. 2. When the driver stops the vehicle, the microprocessor 18 actuates the speaker 24 to broadcast the occupancy alert to notify the driver that the child is in the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. An occupancy alerting device comprising:
a housing configured for positioning in a passenger compartment of a vehicle by a driver transporting a child, the housing defining an interior space, the housing being substantially rectangularly box shaped such that the housing has top and bottom faces, a pair of lateral faces, and a pair of opposing ends, the housing being elongated between the opposing ends;
a power module coupled to the housing and positioned in the interior space;
a microprocessor coupled to the housing and positioned in the interior space, the microprocessor being operationally coupled to the power module;
a detector coupled to the housing and positioned in the interior space, the detector being operationally coupled to the microprocessor, the detector being motion type wherein the detector is configured for detecting motion of the vehicle; and
a speaker coupled to the housing, the speaker being operationally coupled to the microprocessor such that the microprocessor is positioned for selectively actuating the speaker, based on a motion status of the vehicle, for broadcasting an occupancy alert to an area proximate to the housing for alerting the driver to the child in the vehicle, the speaker being positioned on one of the opposing ends of the housing.

2. (canceled)

3. The device of claim 1, further including the power module comprising a battery.

4. The device of claim 1, further including the detector comprising at least one of an accelerometer, a gyroscope, and a compass.

5. The device of claim 4, further including the detector comprising an accelerometer.

6. The device of claim 5, further including the accelerometer being multi-axis type.

7. (canceled)

8. The device of claim 1, further including occupancy alert programming code positioned on the microprocessor enabling the microprocessor for selectively actuating the speaker, based on the motion status of the vehicle, for broadcasting the occupancy alert to the area proximate to the housing for alerting the driver to the child in the vehicle.

9. The device of claim 1, further including a voltmeter coupled to the housing and positioned in the interior space, the voltmeter being operationally coupled to the microprocessor and the battery such that the voltmeter is positioned for relaying a voltage reading of the battery to the microprocessor positioning the microprocessor for selectively actuating the speaker for broadcasting a low voltage alert to the area proximate to the housing for alerting the driver for changing the battery.

10. The device of claim 9, further including low voltage alert programming code positioned on the microprocessor enabling the microprocessor for selectively actuating the speaker, based on the voltage reading of the battery, for broadcasting the low voltage alert to the area proximate to the housing for alerting the driver for changing the battery.

11. The device of claim 1, further including a voltage regulator coupled to the housing and positioned in the interior space, the voltage regulator being operationally coupled to the microprocessor, the detector, and the battery such that the voltage regulator is positioned for providing a constant voltage from the battery to the microprocessor and the detector.

12. An occupancy alerting device comprising:
a housing configured for positioning in a passenger compartment of a vehicle by a driver transporting a child, the housing defining an interior space, the housing being substantially rectangularly box shaped such that the housing has top and bottom faces, a pair of lateral faces, and a pair of opposing ends, the housing being elongated between the opposing ends;
a power module coupled to the housing and positioned in the interior space, the power module comprising a battery;
a microprocessor coupled to the housing and positioned in the interior space, the microprocessor being operationally coupled to the power module;
a detector coupled to the housing and positioned in the interior space, the detector being operationally coupled to the microprocessor, the detector being motion type wherein the detector is configured for detecting motion of the vehicle, the detector comprising at least one of an accelerometer, a gyroscope, and a compass, the detector comprising an accelerometer, the accelerometer being multi-axis type;
a speaker coupled to the housing, the speaker being operationally coupled to the microprocessor such that the microprocessor is positioned for selectively actuating the speaker, based on a motion status of the vehicle, for broadcasting an occupancy alert to an area proximate to the housing for alerting the driver to the child in the vehicle, the speaker being positioned on one of the opposing ends of the housing;
a voltmeter coupled to the housing and positioned in the interior space, the voltmeter being operationally coupled to the microprocessor and the battery such that the voltmeter is positioned for relaying a voltage reading of the battery to the microprocessor positioning the microprocessor for selectively actuating the speaker for broadcasting a low voltage alert to the area proximate to the housing for alerting the driver for changing the battery;
a voltage regulator coupled to the housing and positioned in the interior space, the voltage regulator being operationally coupled to the microprocessor, the detector, and the battery such that the voltage regulator is positioned for providing a constant voltage from the battery to the microprocessor and the detector;
occupancy alert programming code positioned on the microprocessor enabling the microprocessor for selectively actuating the speaker, based on the motion status of the vehicle, for broadcasting the occupancy alert to the area proximate to the housing for alerting the driver to the child in the vehicle; and
low voltage alert programming code positioned on the microprocessor enabling the microprocessor for selectively actuating the speaker, based on the voltage reading of the battery, for broadcasting the low voltage alert to the area proximate to the housing for alerting the driver for changing the battery.
